(19) United States
(12) Patent Application Publication
(10) Pub. No.: US 2005/0171266 A1
(43) Pub. Date: Aug. 4, 2005

(54) Filled compositions and a method of making

(76) Inventors: Johannes G.M. Matthijssen, Wouw (NL); Sai Pei Ting, Selkirk, NY (US)

Correspondence Address: CANTOR COLBURN, LLP, 55 GRIFFIN ROAD SOUTH, BLOOMFIELD, CT, 06002, US

(21) Appl. No.: 11/023,684

(22) Filed: Dec. 28, 2004

Related U.S. Application Data
(63) Continuation-in-part of application No. 10/250,178, filed on Jun. 10, 2003.

(51) Int. Cl. C08K 5/34; C08K 3/04

(52) U.S. Cl. 524/451; 524/495

(57) ABSTRACT

A method of making a thermoplastic composition is disclosed, comprising adding a poly(arylene ether) to a feedthroat of an extruder, adding a polyamide to the extruder downstream of the feedthroat, adding a first masterbatch comprising a polyamide and a carbon black to the extruder downstream of the feedthroat, and adding a second masterbatch comprising a polyamide and a mineral filler to the extruder downstream of the feedthroat. Also disclosed is a composition comprising a poly(arylene ether), polyamide, carbon black, and mineral filler made by this method.

### CROSS REFERENCE TO RELATED APPLICATIONS

This application is a continuation-in-part of U.S patent application No. 10/250,178, filed on Jun. 10, 2003, which is incorporated herein by reference.

### BACKGROUND OF THE INVENTION

The disclosure relates to poly(arylene ether)/polyamide compositions containing mineral fillers, and a method of making these compositions.

The addition of mineral fillers to polymeric material is known to provide materials having improved physical properties such as increased stiffness. Mineral filled polymeric material may be molded into articles by a variety of techniques including injection molding. The molded articles may be painted or undergo further processing to create a finished article. Other uses require excellent surface appearance of the molded article without further processing in order to avoid additional costs, and therefore, it is desirable that the molded article is free from surface blemishes or other defects. In addition, the filled polymeric material should possess stable mechanical strength and impact resistance, under typical environmental conditions including mechanical stresses.

Despite numerous attempts to produce compositions having a combination of impact resistance and surface appearance there remains an ongoing need for compositions having improved impact strength and surface appearance as well as methods of making these compositions.

### BRIEF DESCRIPTION OF THE INVENTION

Disclosed herein are compositions and methods for making the same, as well as articles made from the compositions. In one embodiment, a composition is disclosed comprising a poly(arylene ether), a polyamide, carbon black, and a mineral filler wherein poly(arylene ether) particles are dispersed in a polyamide matrix. Greater than or equal to 95% of the poly(arylene ether) particles have a cross sectional area less than or equal to 2.5 square micrometers, and/or the particles have a maximum particle size of less than or equal to 3.2 micrometers.

In another embodiment, a method of making a thermoplastic comprises adding a poly(arylene ether) to a feedthroat of an extruder, and adding a polyamide, a first masterbatch and a second masterbatch at one or more feedports which are downstream of the feedthroat, wherein the first masterbatch comprises a polyamide and carbon black and the second masterbatch comprises a polyamide and mineral filler.

### DETAILED DESCRIPTION OF THE DRAWINGS

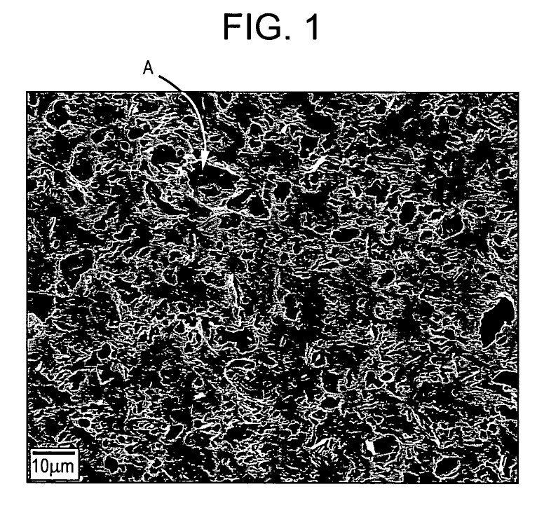

FIG. 1 shows a scanning-electron micrograph (SEM) image of the dispersed poly(arylene ether) phase in a first comparative example.

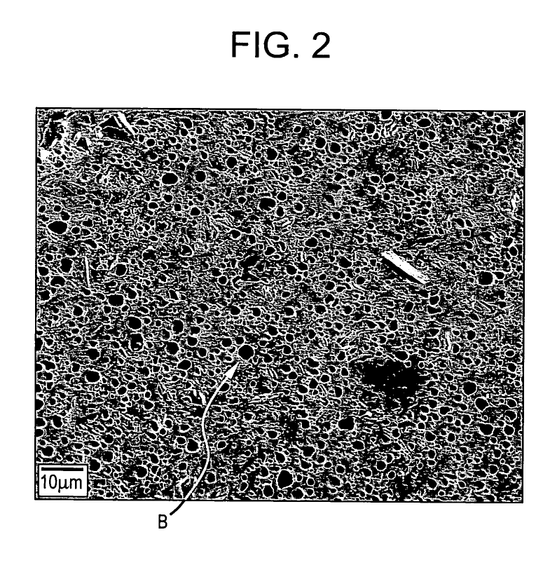

FIG. 2 shows a scanning-electron micrograph (SEM) image of the dispersed poly(arylene ether) phase in a second comparative example.

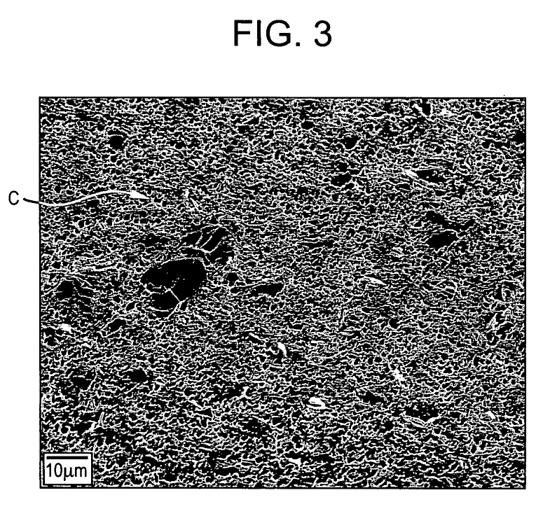

FIG. 3 shows a scanning-electron micrograph (SEM) image of the dispersed poly(arylene ether) phase in a first example.

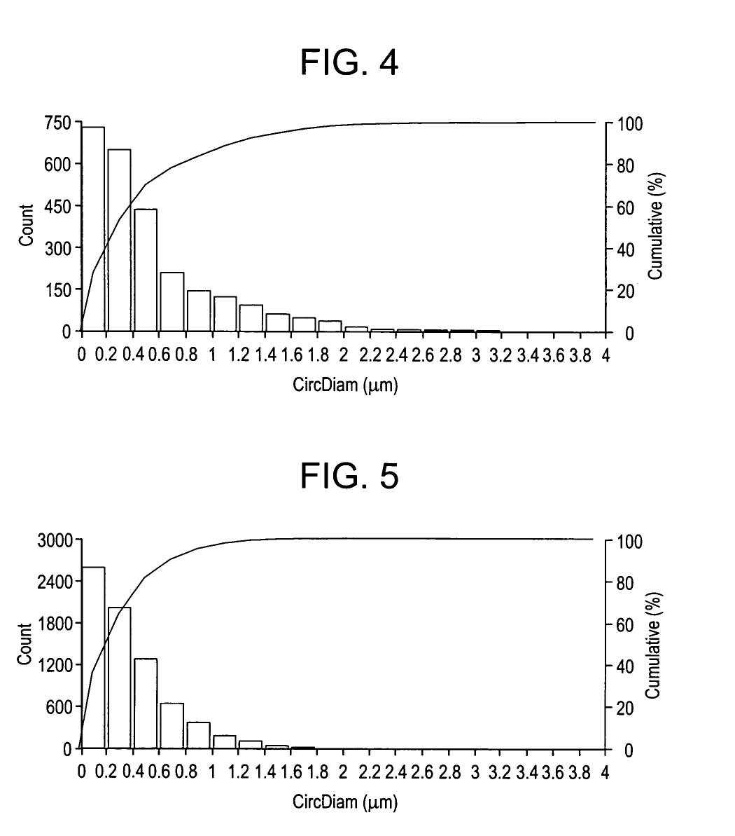

FIG. 4 shows a particle size distribution of a dispersed poly(arylene ether) phase in a comparative example.

FIG. 5 shows a particle size distribution of a dispersed poly(arylene ether) phase in a first example.

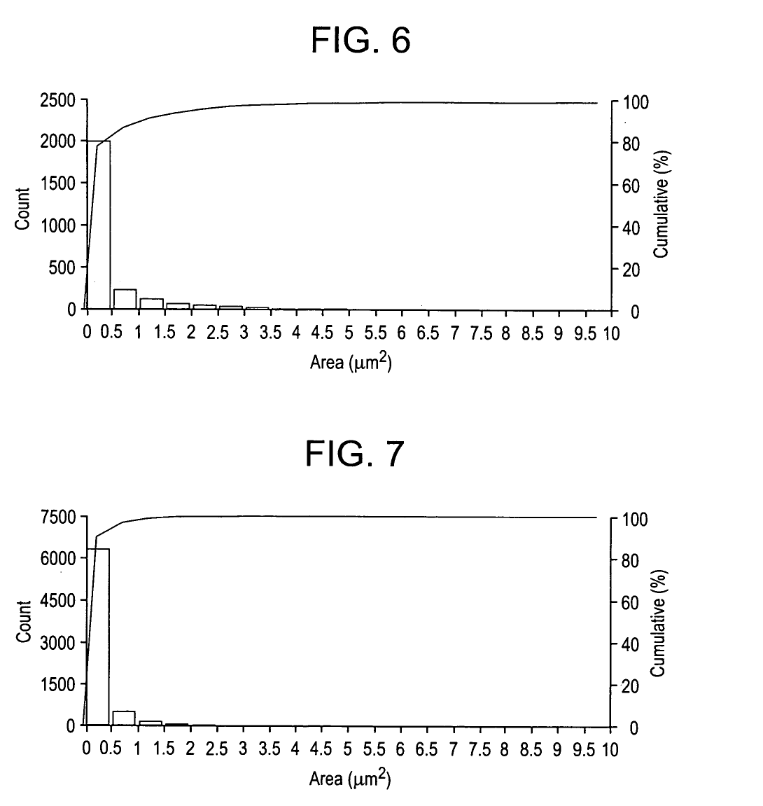

FIG. 6 shows a cross-sectional area distribution of a dispersed poly(arylene ether) phase in a comparative example.

FIG. 7 shows a cross-sectional area distribution of a dispersed poly(arylene ether) phase in a first example.

### DETAILED DESCRIPTION OF THE INVENTION

Compositions comprising a poly(arylene ether) dispersed phase, a polyamide continuous phase, carbon black, and a mineral filler having improved physical properties can be made by employing a carbon black masterbatch and a mineral filler masterbatch wherein the master batches are added, together or separately, at a location or locations which are downstream of the extruder feedthroat. Additionally, at least a portion of the polyamide is added at a location that is downstream of the feedthroat. The polyamide may be added with either masterbatch, both masterbatches or independently. After the pelletized composition has been molded or extruded, the poly(arylene ether) is distributed through a polyamide continuous phase or matrix, and the particle size of the poly(arylene ether) is related to the method of making the thermoplastic composition.

In one aspect, molded or extruded articles comprising a filled polymeric material comprising greater than or equal to 1 part by weight carbon black based on the total weight of the filled polymeric material exhibit an improved surface appearance when compared to molded articles comprising similar compositions not containing carbon black. When the filled material further comprises carbon black, the carbon black functions as an external lubricant and reduces the friction force between the filled polymeric material melt and the cold mold surface thus improving the surface aesthetic of the molded article by reducing the amount of splay. Further, addition of the carbon black is more effective in presenting a low defectivity appearance when dispersed as a masterbatch and not when the carbon black is added as a separate ingredient. The carbon black masterbatch comprises a carbon black and a polyamide diluent. Additionally, the compositions further comprise a mineral filler, which when added dispersed in a polyamide as a masterbatch, increase stiffness of the compositions.

While not wishing to be bound by theory, it is believed that the use of a carbon black masterbatch and a mineral filler masterbatch surprisingly has an effect on the poly(arylene ether) particle size in the final articles. The relatively small particle size and approximately uniform distribution of the poly(arylene ether) particles confers improved impact strength to the final article.

As used herein, a “poly(arylene ether)” comprises a plurality of structural units of the formula (I): 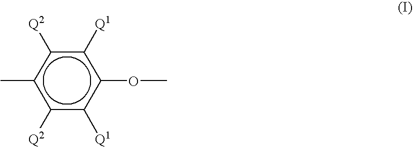
wherein for each structural unit, each Q¹ and Q² is independently hydrogen, halogen, primary or secondary lower alkyl (e.g., an alkyl containing 1 to 7 carbon atoms), phenyl, haloalkyl, aminoalkyl, alkenylalkyl, alkynylalkyl, hydrocarbonoxy, aryl and halohydrocarbonoxy wherein at least two carbon atoms separate the halogen and oxygen atoms. In some embodiments, each Q¹ is independently alkyl or phenyl, for example, C₁₋₄ alkyl, and each Q² is independently hydrogen or methyl. The poly(arylene ether) may comprise molecules having aminoalkyl-containing end group(s), typically located in an ortho position to the hydroxy group. Also frequently present are tetramethyl diphenylquinone (TMDQ) endgroups, typically obtained from reaction mixtures in which tetramethyl diphenylquinone by-product is present.

The poly(arylene ether) may be in the form of a homopolymer; a copolymer; a graft copolymer; an ionomer; a block copolymer, for example comprising arylene ether units and blocks derived from alkenyl aromatic compounds; as well as combinations comprising at least one of the foregoing. Poly(arylene ether) includes polyphenylene ether containing 2,6-dimethyl-1,4-phenylene ether units optionally in combination with 2,3,6-trimethyl-1,4-phenylene ether units.

The poly(arylene ether) may be prepared by the oxidative coupling of monohydroxyaromatic compound(s) such as 2,6-xylenol and/or 2,3,6-trimethylphenol. Catalyst systems are generally employed for such coupling; they can contain heavy metal compound(s) such as a copper, manganese or cobalt compound, usually in combination with various other materials such as a secondary amine, tertiary amine, halide or combination of two or more of the foregoing.

The poly(arylene ether) can have a number average molecular weight of 3,000 to 40,000 grams per mole (g/mol) and/or a weight average molecular weight of about 5,000 to about 80,000 g/mol, as determined by gel permeation chromatography using monodisperse polystyrene standards, a styrene divinyl benzene gel at 40° C. and samples having a concentration of 1 milligram per milliliter of chloroform. The poly(arylene ether) can have an intrinsic viscosity of 0.10 to 0.60 deciliters per gram (dl/g), or, more specifically, 0.29 to 0.48 dl/g, as measured in chloroform at 25° C. It is possible to utilize a combination of high intrinsic viscosity poly(arylene ether) and a low intrinsic viscosity poly(arylene ether). Determining an exact ratio, when two intrinsic viscosities are used, will depend somewhat on the exact intrinsic viscosities of the poly(arylene ether) used and the ultimate physical properties that are desired.

The composition comprises poly(arylene ether) in an amount of 15 to 65 weight percent. Within this range, the poly(arylene ether) may be present in an amount greater than or equal to 30 weight percent, or, more specifically, in an amount greater than or equal to 35 weight percent, or, even more specifically, in an amount greater than or equal to 40 weight percent. Also within this range the poly(arylene ether) may be present in an amount less than or equal to 60 weight percent, or, more specifically, less than or equal to 55 weight percent, or, even more specifically, less than or equal to 50 weight percent. Weight percent is based on the total weight of the thermoplastic composition.

Polyamide resins, also known as nylons, are characterized by the presence of an amide group (—C(O)NH—), and are described in U.S. Pat. No. 4,970,272. Exemplary polyamide resins include, but are not limited to, nylon-6; nylon-6,6; nylon-4; nylon-4,6; nylon-12; nylon-6,10; nylon 6,9; nylon-6,12; amorphous polyamide resins; nylon 6/6T and nylon 6,6/6T with triamine contents below 0.5 weight percent; and combinations of two or more of the foregoing polyamides. In one embodiment, the polyamide resin comprises nylon 6 and nylon 6,6. In one embodiment the polyamide resin or combination of polyamide resins has a melting point (Tₘ) greater than or equal to 171° C. When the polyamide comprises a super tough polyamide, i.e. a rubber-toughed polyamide, the composition may or may not contain a separate impact modifier.

Polyamide resins may be obtained by a number of well known processes such as those described in U.S. Pat. Nos. 2,071,250; 2,071,251; 2,130,523; 2,130,948; 2,241,322; 2,312,966; and 2,512,606. Polyamide resins are commercially available from a wide variety of sources.

Polyamide resins having an intrinsic viscosity of up to 400 milliliters per gram (ml/g) can be used, or, more specifically, having a viscosity of 90 to 350 ml/g, or, even more specifically, having a viscosity of 110 to 240 ml/g, as measured in a 0.5 wt % solution in 96 wt % sulfuric acid in accordance with ISO 307.

The polyamide may have a relative viscosity of up to 6, or, more specifically, a relative viscosity of 1.89 to 5.43, or, even more specifically, a relative viscosity of 2.16 to 3.93. Relative viscosity is determined according to DIN 53727 in a 1 wt % solution in 96 wt % sulfuric acid.

In one embodiment, the polyamide resin comprises a polyamide having an amine end group concentration greater than or equal to 35 microequivalents amine end group per gram of polyamide (ηeq/g) as determined by titration with HCl. Within this range, the amine end group concentration may be greater than or equal to 40 μeq/g, or, more specifically, greater than or equal to 45 μeq/g. Amine end group content may be determined by dissolving the polyamide in a suitable solvent, optionally with heat. The polyamide solution is titrated with 0.01 Normal hydrochloric acid (HCl) solution using a suitable indication method. The amount of amine end groups is calculated based the volume of HCl solution added to the sample, the volume of HCl used for the blank, the molarity of the HCl solution and the weight of the polyamide sample.

The composition comprises polyamide in an amount of 30 to 85 weight percent. Within this range, the polyamide may be present in an amount greater than or equal to 33 weight percent, or, more specifically, in an amount greater than or equal to 38 weight percent, or, even more specifically, in an amount greater than or equal to 40 weight percent. Also within this range, the polyamide may be present in an amount less than or equal to 60 weight percent, or, more specifically, less than or equal to 55 weight percent, or, even more specifically, less than or equal to 50 weight percent. Weight percent is based on the total weight of the thermoplastic composition.

When used herein, the expression “compatibilizing agent” refers to polyfunctional compounds which interact with the poly(arylene ether), the polyamide resin, or both. This interaction may be chemical (e.g., grafting) and/or physical (e.g., affecting the surface characteristics of the dispersed phases). In either instance the resulting compatibilized poly(arylene ether)/polyamide composition appears to exhibit improved compatibility, particularly as evidenced by enhanced impact strength, mold knit line strength and/or elongation. As used herein, the expressions “compatibilized poly(arylene ether)” or “compatibilized poly(arylene ether)/polyamide blend” refers to those compositions which have been physically and/or chemically compatibilized with an agent as discussed above, as well as those compositions which are physically compatible without such agents, as taught in U.S. Pat. No. 3,379,792.

Examples of the various compatibilizing agents that may be employed include: liquid diene polymers, epoxy compounds, oxidized polyolefin wax, quinones, organosilane compounds, polyfunctional compounds, functionalized poly(arylene ether) and combinations comprising at least one of the foregoing. Compatibilizing agents are further described in U.S. Pat. Nos. 5,132,365 and 6,593,411 as well as U.S. patent application No. 2003/0166762.

In one embodiment, the compatibilizing agent comprises a polyfunctional compound. Polyfunctional compounds which may be employed as a compatibilizing agent are of three types. The first type of polyfunctional compounds are those having in the molecule both (a) a carbon-carbon double bond or a carbon-carbon triple bond and (b) at least one carboxylic acid, anhydride, amide, ester, imide, amino, epoxy, orthoester, or hydroxy group. Examples of such polyfunctional compounds include maleic acid; maleic anhydride; fumaric acid; glycidyl acrylate, itaconic acid; aconitic acid; maleimide; maleic hydrazide; reaction products resulting from a diamine and maleic anhydride, maleic acid, fumaric acid, etc.; dichloro maleic anhydride; maleic acid amide; unsaturated dicarboxylic acids (e.g., acrylic acid, butenoic acid, methacrylic acid, t-ethylacrylic acid, pentenoic acid); decenoic acids, undecenoic acids, dodecenoic acids, linoleic acid, etc.); esters, acid amides or anhydrides of the foregoing unsaturated carboxylic acids; unsaturated alcohols (e.g. alkyl alcohol, crotyl alcohol, methyl vinyl carbinol, 4-pentene-1-ol, 1,4-hexadiene-3-ol, 3-butene-1,4-diol, 2,5-dimethyl-3-hexene-2,5-diol and alcohols of the formula CₙH₂ₙ₋₅OH, CₙH₂ₙ₋₇OH and CₙH₂ₙ₋₉OH, wherein n is a positive integer less than or equal to 30); unsaturated amines resulting from replacing from replacing the —OH group(s) of the above unsaturated alcohols with NH₂ groups; functionalized diene polymers and copolymers; and combinations comprising one or more of the foregoing. In one embodiment, the compatibilizing agent comprises maleic anhydride and/or fumaric acid.

The second type of polyfunctional compatibilizing agents are characterized as having both (a) a group represented by the formula (OR) wherein R is hydrogen or an alkyl, aryl, acyl or carbonyl dioxy group and (b) at least two groups each of which may be the same or different selected from carboxylic acid, acid halide, anhydride, acid halide anhydride, ester, orthoester, amide, imido, amino, and various salts thereof. Typical of this group of compatibilizers are the aliphatic polycarboxylic acids, acid esters and acid amides represented by the formula:
(R^{I}O)ₘR(COOR^{II})ₙ(CONR^{III}R^{IV})ₛ
wherein R is a linear or branched chain, saturated aliphatic hydrocarbon having 2 to 20, or, more specifically, 2 to 10, carbon atoms; R^{I} is hydrogen or an alkyl, aryl, acyl, or carbonyl dioxy group having 1 to 10, or, more specifically, 1 to 6, or, even more specifically, 1 to 4 carbon atoms; each R^{II} is independently hydrogen or an alkyl or aryl group having 1 to 20, or, more specifically, 1 to 10 carbon atoms; each R^{III} and R^{IV} are independently hydrogen or an alkyl or aryl group having 1 to 10, or, more specifically, 1 to 6, or, even more specifically, 1 to 4, carbon atoms; m is equal to 1 and (n+s) is greater than or equal to 2, or, more specifically, equal to 2 or 3, and n and s are each greater than or equal to zero and wherein (OR^{I}) is alpha or beta to a carbonyl group and at least two carbonyl groups are separated by 2 to 6 carbon atoms. Obviously, R^{I}, R^{II}, R^{III}, and R^{IV} cannot be aryl when the respective substituent has less than 6 carbon atoms.

Suitable polycarboxylic acids include, for example, citric acid, malic acid, agaricic acid; including the various commercial forms thereof, such as for example, the anhydrous and hydrated acids; and combinations comprising one or more of the foregoing. In one embodiment, the compatibilizing agent comprises citric acid. Illustrative of esters useful herein include, for example, acetyl citrate, mono- and/or distearyl citrates, and the like. Suitable amides useful herein include, for example, N,N′-diethyl citric acid amide; N-phenyl citric acid amide; N-dodecyl citric acid amide; N,N′-didodecyl citric acid amide; and N-dodecyl malic acid. Derivates include the salts thereof, including the salts with amines and the alkali and alkaline metal salts. Exemplary of suitable salts include calcium malate, calcium citrate, potassium malate, and potassium citrate.

The third type of polyfunctional compatibilizing agents are characterized as having in the molecule both (a) an acid halide group and (b) at least one carboxylic acid, anhydride, ester, epoxy, orthoester, or amide group. Examples of compatibilizers within this group include trimellitic anhydride acid chloride, chloroformyl succinic anhydride, chloro formyl succinic acid, chloroformyl glutaric anhydride, chloroformyl glutaric acid, chloroacetyl succinic anhydride, chloroacetylsuccinic acid, trimellitic acid chloride, and chloroacetyl glutaric acid. In one embodiment, the compatibilizing agent comprises trimellitic anhydride acid chloride.

The foregoing compatibilizing agents may be added directly to the melt blend or pre-reacted with either of the poly(arylene ether) and polyamide individually or in combination, as well as with other resinous materials employed in the preparation of the composition. With many of the foregoing compatibilizing agents, particularly the polyfunctional compounds, even greater improvement in compatibility is found when at least a portion of the compatibilizing agent is pre-reacted, either in the melt or in a solution of a suitable solvent, with all or a part of the poly(arylene ether). It is believed that such pre-reacting may cause the compatibilizing agent to react with the polymer and, consequently, functionalize the poly(arylene ether). For example, the poly(arylene ether) may be pre-reacted with maleic anhydride to form an anhydride functionalized polyphenylene ether which has improved compatibility with the polyamide compared to a non-functionalized polyphenylene ether.

Where the compatibilizing agent is employed in the preparation of the compositions, the amount used will be dependent upon the specific compatibilizing agent chosen and the specific polymeric system to which it is added.

The composition further comprises carbon black. Suitable carbon blacks are those having average particle sizes less than 100 nanometers (m-n), or, specifically, less than 75 nm, or more specifically, less than 50 nm, or even more specifically less than about 40 nm. In addition, carbon blacks may also have surface area greater than about 20 square meters per gram (m²/g), or, more specifically, greater than about 40 m²/g. The carbon black may have a surface area less than or equal to 175 m²/g, or, more specifically, less than or equal to 165 m²/g, or, even more specifically, less than or equal to 155 m²/g. Suitable carbon black is distinguished from conductive carbon black in having minimal or no electrical conductivity. Commercially available carbon blacks are sold under a variety of trade names, and in a number of different forms including dry processed pellets under the trade name BLACK PEARLS™, as wet processed pellets under the trade names ELFTEX™, REGAL™, and CSX™, and in a fluffy form including MONARCH™, ELFTEX™, REGAL™, and MOGUL™, all from Cabot Corporation. These carbon blacks are available in particle sizes of 20 to 50 nanometers (nm) and with surface areas of 35 to 138 square meters per gram (m²/g). A non-limiting example of a specific suitable carbon black is VULCAN™ 9A32, from Cabot Corporation, available in pelletized form. In one embodiment, conductive carbon black may be used in addition to the carbon black. The carbon black(s) maybe treated or untreated.

The carbon black is present in the composition in amounts of about 0.001 to about 5.0 weight percent based on the total weight of the composition. Within this range an amount of carbon black of less than or equal to about 5.0 weight percent can be employed, specifically with less than or equal to about 3.5 weight percent, and more specifically less than or equal to about 1.5 weight percent. Also within this range is an amount of carbon black of greater than or equal to about 0.005 weight percent, specifically greater than or equal to about 0.01 weight percent, or, more specifically greater than or equal to about 0.015 weight percent.

While not wishing to be bound by any particular theory, it is believed the carbon black functions as an external lubricant which reduces the friction force between the mineral filler containing polymer melt and the cold mold surface, thus improving the surface aesthetic of the molded article by reducing the amount of splay.

The composition further comprises one or more mineral fillers, and optionally non-mineral fillers such as non-mineral low-aspect ratio fillers, non-mineral fibrous fillers, and polymeric fillers. Non-limiting examples of mineral fillers include silica powder, such as fused silica, crystalline silica, natural silica sand, and various silane-coated silicas; boron-nitride powder and boron-silicate powders; alumina and magnesium oxide (or magnesia); wollastonite including surface-treated wollastonite; calcium sulfate (as, for example, its dihydrate or trihydrate); calcium carbonates including chalk, limestone, marble and synthetic, precipitated calcium carbonates, generally in the form of a ground particulate which often comprises 98+% CaCO₃ with the remainder being other inorganics such as magnesium carbonate, iron oxide and alumino-silicates; surface-treated calcium carbonates; talc, including fibrous, modular, needle shaped, and lamellar talcs; kaolin, including hard, soft, calcined kaolin, and kaolin comprising various coatings known to the art to facilitate dispersion and compatibility; mica, including metallized mica and mica surface treated with aminosilanes or acryloylsilanes coatings to impart good physicals to compounded blends; feldspar and nepheline syenite; silicate spheres; flue dust; cenospheres; fillite; aluminosilicate (armospheres), including silanized and metallized aluminosilicate; quartz; quartzite; perlite; Tripoli; diatomaceous earth; silicon carbide; molybdenum sulfide; zinc sulfide; aluminum silicate (mullite); synthetic calcium silicate; zirconium silicate; barium titanate; barium ferrite; barium sulfate and heavy spar; particulate or fibrous aluminum, bronze, zinc, copper and nickel; flaked fillers and reinforcements such as glass flakes, flaked silicon carbide, aluminum diboride, aluminum flakes, and steel flakes; processed mineral fibers such as those derived from blends comprising at least one of aluminum silicates, aluminum oxides, magnesium oxides, and calcium sulfate hemihydrate; glass fibers, including textile glass fibers such as E, A, C, ECR, R, S, D, and NE glasses; and vapor-grown carbon fibers include those having an average diameter of about 3.5 to about 500 nanometers as described in, for example, U.S. Pat. Nos. 4,565,684 and 5,024,818 to Tibbetts et al., U.S. Pat. No. 4,572,813 to Arakawa; U.S. Pat. Nos. 4,663,230 and 5,165,909 to Tennent, U.S. Pat. No. 4,816,289 to Komatsu et al., U.S. Pat. No. 4,876,078 to Arakawa et al., U.S. Pat. No. 5,589,152 to Tennent et al., and U.S. Pat. No. 5,591,382 to Nahass et al.; and the like.

Exemplary mineral fillers include inorganic fillers that have an average particle size of 5 mm or less and an aspect ratio of 3 or more. Such mineral fillers include talc, kaolinite, micas (e.g., sericite, muscovite and phlogopite), chlorite, montmorillonite, smectite and halloysite.

The mineral filler is present in the composition in amounts of about 5 to about 50 weight percent based on the total weight of the composition. Within this range an amount of mineral filler of less than or equal to about 45 weight percent can be employed, or, more specifically, less than or equal to about 40 weight percent, or, even more specifically, less than or equal to about 35 weight percent. Also within this range is an amount of mineral filler of greater than or equal to about 10 weight percent, or, more specifically, greater than or equal to about 15 weight percent, or, even more specifically, greater than or equal to about 20 weight percent especially. The non-mineral fillers may be used in an amount of about 95 to about 50 weight percent based on the total weight of the composition.

Non-limiting examples of non-mineral fillers include natural fibers; synthetic reinforcing fibers, including polyester fibers such as polyethylene terephthalate fibers, polyvinylalcohol fibers, aromatic polyamide fibers, polybenzimidazole fibers, polyimide fibers, polyphenylene sulfide fibers, polyether ether ketone fibers; and the like.

A masterbatch generally refers to a dispersion of particles in a carrier, typically in a pelletized or beaded form that was formed using a mixing process such as a compounding/extrusion process. The carrier is usually a thermoplastic resin but could also be a wax or similar carrier that would be compatible with the final resin where the masterbatch will be used. A masterblend generally refers to a dispersion of the particles in a powder carrier. The masterblend is typically obtained by mechanical mixing of the particles with the carrier using standard blending equipment (e.g. blenders, mixers and the like). Carriers include, but are not limited to polyamides, examples of which include, nylon 6,6, nylon 6, blends thereof, and the like. An exemplary carbon black masterbatch comprises a 20% dispersion of Cabot carbon black with 80% DuPont prime nylon, available as RO7911 from Clariant Corporation. An exemplary mineral filler masterbatch comprises talc with nylon 6.

The compositions may further comprise impact modifiers, which include natural and synthetic polymer substances that are elastic bodies at room temperature. Impact modifiers can be block copolymers containing alkenyl aromatic repeating units, for example, A-B diblock copolymers and A-B-A triblock copolymers having of one or two alkenyl aromatic blocks A (blocks having alkenyl aromatic repeating units), which are typically styrene blocks, and a rubber block, B, which is typically an isoprene or butadiene block. The butadiene block may be partially or completely hydrogenated. Mixtures of these diblock and triblock copolymers may also be used as well as mixtures of non-hydrogenated copolymers, partially hydrogenated copolymers, fully hydrogenated copolymers and combinations of two or more of the foregoing.

A-B and A-B-A copolymers include, but are not limited to, polystyrene-polybutadiene, polystyrene-poly(ethylene-propylene), polystyrene-polyisoprene, poly(a-methylstyrene)-polybutadiene, polystyrene-polybutadiene-polystyrene (SBS), polystyrene-poly(ethylene-propylene)-polystyrene, polystyrene-polyisoprene-polystyrene and poly(alpha-methylstyrene)-polybutadiene-poly(alpha-methylstyrene), polystyrene-poly(ethylene-propylene-styrene)-polystyrene, and the like. Mixtures of the aforementioned block copolymers are also useful. Such A-B and A-B-A block copolymers are available commercially from a number of sources, including Phillips Petroleum under the trademark SOLPRENE, Kraton Polymers, under the trademark KRATON, Dexco under the trademark VECTOR, Asahi Kasai under the trademark TUFTEC, Total Petrochemicals under the trademarks FINAPRENE and FINACLEAR and Kuraray under the trademark SEPTON.

In one embodiment, the impact modifier comprises polystyrene-poly(ethylene-butylene)-polystyrene, polystyrene-poly(ethylene-propylene) or a combination of the foregoing.

Another type of impact modifier is essentially free of alkenyl aromatic repeating units and comprises one or more moieties selected from the group consisting of carboxylic acid, anhydride, epoxy, oxazoline, and orthoester. Essentially free is defined as having alkenyl aromatic unita present in an amount less than 5 weight percent, or, more specifically, less than 3 weight percent, or, even more specifically less than 2 weight percent, based on the total weight of the block copolymer. When the impact modifier comprises a carboxylic acid moiety the carboxylic acid moiety may be neutralized with an ion, like a metal ion such as zinc or sodium. It may be an alkylene-alkyl (meth)acrylate copolymer and the alkylene groups may have 2 to 6 carbon atoms and the alkyl group of the alkyl (meth)acrylate may have 1 to 8 carbon atoms. This type of polymer can be prepared by copolymerizing an olefin, for example, ethylene and propylene, with various (meth)acrylate monomers and/or various maleic-based monomers. The term (meth)acrylate refers to both the acrylate as well as the corresponding methacrylate analogue. Included within the term (meth)acrylate monomers are alkyl (meth)acrylate monomers as well as various (meth)acrylate monomers containing at least one of the aforementioned reactive moieties.

In a one embodiment, the copolymer is derived from ethylene, propylene, or mixtures of ethylene and propylene, as the alkylene component; butyl acrylate, hexyl acrylate, or propyl acrylate as well as the corresponding alkyl (methyl)acrylates, for the alkyl (meth)acrylate monomer component, with acrylic acid, maleic anhydride, glycidyl methacrylate or a combination thereof as monomers providing the additional reactive moieties (i.e., carboxylic acid, anhydride, epoxy).

Exemplary first impact modifiers are commercially available from a variety of sources including ELVALOY PTW, SURLYN, and FUSABOND, all of which are available from DuPont.

The aforementioned impact modifiers can be used singly or in combination.

The composition may comprise an impact modifier or a combination of impact modifiers, in an amount of 1 to 15 weight percent. Within this range, the impact modifier may be present in an amount greater than or equal to 1.5 weight percent, or, more specifically, in an amount greater than or equal to 2 weight percent, or, even more specifically, in an amount greater than or equal to 4 weight percent. Also within this range, the impact modifier may be present in an amount less than or equal to 13 weight percent, or, more specifically, less than or equal to 12 weight percent, or, even more specifically, less than or equal to 10 weight percent. Weight percent is based on the total weight of the thermoplastic composition.

The thermoplastic composition may additionally comprise other additives such as rheology modifiers, buffers, thermal stabilizers, light stabilizers, antioxidants, anti-yellowing agents, pigments, dyes, and the like. It will be noted that, within the context of this disclosure, determining the appropriate additives and amounts thereof is within the capability of one skilled in the art.

In one embodiment, a premix comprising a poly(arylene ether), optional impact modifier, and a compatibilizer is prepared. The premix is then fed into the throat of a twin-screw extruder. Alternatively the poly(arylene ether), optional impact modifier and compatibilizer can be added to the feedthroat without being blended to form a premix.

A carbon black masterbatch, a talc masterbatch, and a polyamide are fed into the extruder, singly or in combinations of two or more, via one or more feedports downstream of the feedthroat. In another embodiment, the carbon black masterbatch, talc masterbatch, and polyamide may be blended to form a premix prior to adding into a downstream feedport. The extrudate may be quenched in a water batch and cut to form pellets, or alternatively is directly molded or extruded to a suitable form. Pellets so prepared when cutting the extrudate may be 0.65 centimeters long or less.

While separate extruders may be used in the processing, preparations in a single extruder having multiple feed ports along its length to accommodate the addition of the various components simplifies the process. It is often advantageous to apply a vacuum to the melt through one or more vent ports in the extruder to remove volatile impurities in the composition. The preparation of the composition is normally achieved by blending the ingredients under conditions for the formation of an intimate blend.

It has been surprisingly found that the addition of the poly(arylene ether), compatibilizer, and other additives to the feedthroat of the extruder, and the addition of carbon black masterbatch, talc masterbatch, and polyamide to a downstream feedport of the extruder, has the effect of producing a small, relatively uniform particle size in the poly(arylene ether) phase as dispersed in the continuous polyamide phase of the composition. In one embodiment, greater than or equal to 95%, or, more specifically, greater than or equal to 97%, or, even more specifically, greater than or equal to 99% of the poly(arylene ether) particles have a cross sectional area less than or equal to 2.5 square micrometers. In one embodiment, greater than or equal to 95%, or more specifically, greater than or equal to 97%, or even more specifically, greater than or equal to 99% of the poly(arylene ether) particles have a cross sectional area less than or equal to 2.0 square micrometers. In another embodiment, greater than or equal to 95%, or more specifically, greater than or equal to 97%, or even more specifically, greater than or equal to 99% of the poly(arylene ether) particles have a cross sectional area less than or equal to 1.5 square micrometers. Additionally the maximum cross sectional area may be less than or equal to 4.5 square micrometers, or, more specifically, less than or equal to 4.0 square micrometers, or, even more specifically, less than or equal to 3.5 square micrometers.

In one embodiment, the poly(arylene ether) particles have a maximum particle size of less than or equal to 3.2 micrometers, or, more specifically less than or equal to 3.0 micrometers, or, even more specifically, less than or equal to 2.8 micrometers. In one embodiment, greater than or equal to 95%, or, more specifically, greater than or equal to 97%, or, even more specifically, greater than or equal to 99% of the poly(arylene ether) particles have a particle size less than or equal to 1.8 micrometers. In another embodiment, greater than or equal to 95%, or, more specifically, greater than or equal to 97%, or, even more specifically, greater than or equal to 99% of the poly(arylene ether) particles have a particle size less than or equal to 1.6 micrometers. In one embodiment, greater than or equal to 95%, or, more specifically, greater than or equal to 97%, or, even more specifically, greater than or equal to 99% of the poly(arylene ether) particles have a particle size of less than or equal to 1.4 micrometers. Particle size is defined herein as the longest linear dimension of a particle in cross section.

Determinations regarding amounts of particles having an area less than a particular cross-sectional area and maximum particle size are based on measurements of 100 or more particles as described below.

It will also be appreciated by one skilled in the art that the dispersed regions of poly(arylene ether), as disclosed herein, are also substantially regular in shape, forming smooth, discrete boundaries within the continuous matrix without substantial interconnectedness of the dispersed phase. It will further be appreciated by one skilled in the art that, in one embodiment, a dispersed region may have a long axis coincident with the direction of extrusion of the thermoplastic composition. A cross-section of an extruded article of this embodiment, taken orthogonal to the direction of flow, may appear substantially circular in shape, while a cross-section taken along the direction of flow in an extruded article may appear elongated.

The particle area may be determined by scanning electron microscopy. The composition is injection molded into ASTM tensile bars at a melt temperature of 305° C. with a mold temperature of 120° C. A sample is cut at about the midpoint of the bar, between the injection gate and the end of the bar, orthogonal to the direction of composition flow in the mold. A #23 scalpel blade is used to shape the cut end of the sample into a pyramidal shape, wherein enough material is removed to expose the core of the sample. The shaped sample is then mounted on a Leica-Reichert Ultra-cut S microtome chuck, and cut at room temperature using a Microstar Ultra Cut diamond knife to produce a flat microtomed surface for imaging.

The poly(arylene ether) is soluble in a low-polarity organic solvent such as toluene, and so may be extracted from the insoluble sample matrix to provide greater contrast between the continuous and dispersed phases. The sample is thus held using forceps for 15 seconds in a 4 ounce bottle of toluene during sonication in a Branson model 2200 ultrasonic cleaner to remove the poly(arylene ether). The sample is removed from the toluene and dried under a stream of low-particulate air to evaporate any remaining toluene from the microtomed surface. Mounting the sample onto an aluminum SEM stub is done using self-sticking adhesive tabs, and the base and sides of the sample are painted with conductive carbon adhesive. The mounted sample is sputter coated with gold for 50 seconds using a Pelco model 3 sputter coater 91000, to provide a sufficient amount of surface gold for SEM contrast and charge dissipation. The sample is placed in an Amray 18301 scanning electron microscope at 15 kilovolts (kV), and images are captured at 300×, 500×, 1 kX, 2 kX, and 5 kX magnification using Semi-caps digital capture software. For comparison purposes, a single magnification for all SEM image is used. A specific useful magnification for the size ranges of the particles measured herein is 2 kX magnification.

Referring now to the captured SEM images in the Figures, the darkest areas or declivities (for example, “A” in FIG. 1, “B” in FIG. 2, and “C” in FIG. 3) correspond to voids remaining after extraction of the poly(phenylene ether) particles, and hence corresponds to poly(arylene ether) particle size. The image is calibrated with reference to the scale bar and the poly(arylene ether) particles are more distinctly delineated by accentuating the contrast. The particle size distribution is then analyzed with appropriate image analysis software such as Clemex Vision PE to determine the particle area and particle size.

The above-described thermoplastic compositions may be converted to articles using common thermoplastic processes such as film and sheet extrusion, injection molding, gas-assist injection molding, extrusion molding, compression molding and blow molding. Film and sheet extrusion processes may include and are not limited to melt casting, blown film extrusion and calendaring. Co-extrusion and lamination processes may be employed to form composite multi-layer films or sheets. Single or multiple layers of coatings may further be applied to the single or multi-layer substrates to impart additional properties such as scratch resistance, ultra violet light resistance, aesthetic appeal, etc. Coatings may be applied through standard application techniques such as rolling, spraying, dipping, brushing, or flow-coating. Film and sheet of the invention may alternatively be prepared by casting a solution or suspension of the composition in a suitable solvent onto a substrate, belt or roll followed by removal of the solvent.

Oriented films may be prepared through blown film extrusion or by stretching cast or calendared films in the vicinity of the thermal deformation temperature using conventional stretching techniques. For instance, a radial stretching pantograph may be employed for multi-axial simultaneous stretching; an x-y direction stretching pantograph can be used to simultaneously or sequentially stretch in the planar x-y directions. Equipment with sequential uniaxial stretching sections can also be used to achieve uniaxial and biaxial stretching, such as a machine equipped with a section of differential speed rolls for stretching in the machine direction and a tenter frame section for stretching in the transverse direction.

The compositions may be converted to a multi-wall sheet comprising a first sheet having a first side and a second side, wherein the first sheet comprises a thermoplastic polymer, and wherein the first side of the first sheet is disposed upon a first side of a plurality of ribs; and a second sheet having a first side and a second side, wherein the second sheet comprises a thermoplastic polymer, wherein the first side of the second sheet is disposed upon a second side of the plurality of ribs, and wherein the first side of the plurality of ribs is opposed to the second side of the plurality of ribs.

The films and sheets described above may further be thermoplastically processed into shaped articles via forming and molding processes including but not limited to thermoforming, vacuum forming, pressure forming, injection molding and compression molding. Multi-layered shaped articles may also be formed by injection molding a thermoplastic resin onto a single or multi-layer film or sheet substrate as described below:
1. Providing a single or multi-layer thermoplastic substrate having optionally one or more colors on the surface, for instance, using screen printing or a transfer dye
2. Conforming the substrate to a mold configuration such as by forming and trimming a substrate into a three dimensional shape and fitting the substrate into a mold having a surface which matches the three dimensional shape of the substrate.
3. Injecting a thermoplastic resin into the mold cavity behind the substrate to (i) produce a one-piece permanently bonded three-dimensional product or (ii) transfer a pattern or aesthetic effect from a printed substrate to the injected resin and remove the printed substrate, thus imparting the aesthetic effect to the molded resin.

Those skilled in the art will also appreciate that common curing and surface modification processes including and not limited to heat-setting, texturing, embossing, corona treatment, flame treatment, plasma treatment and vacuum deposition may further be applied to the above articles to alter surface appearances and impart additional functionalities to the articles.

Accordingly, another embodiment relates to articles, sheets and films prepared from the compositions above.

The following non-limiting examples further illustrate the various embodiments described herein.

### EXAMPLES

Composition. The following components and proportions, shown in Table 1, were used for the compositions prepared in each of the following examples:

TABLE 1

| Component Nunber | Material | Weight percent (wt %) |
|---|---|---|
| Component 1* | Poly(phenylene ether) | 23.26% |
| Component 2⁴ | SEBS (impact modifier) | 5.82% |
| Component 3 | Mineral oil | 0.97% |
| Component 4 | Citric acid | 0.68% |
| Component 5 | Thermal stabilizer | 0.29% |
| Component 6 | 33% aq. KI solution | 0.15% |
| Component 7 | CuI | 0.01% |
| Component 8¹ | Nylon 6,6 | 17.47% |
| Component 9² | CB-nylon MB | 9.69% |
| Component 10³ | Talc-nylon MB | 41.68% |

*The poly(arylene ether) used in the examples is poly(phenylene ether) or PPE.
¹Nylon 6,6 is Rhodia nylon 6,6.
²CB-nylon MB is a 20% carbon black (Cabot)/80% nylon 66 (Du Pont prime nylon) masterbatch as supplied by Clariant.
³Talc-nylon MB is a 45% talc/55% nylon 66 (Rhodia) and nylon 6 (Rhodia) master batch as supplied by Clariant.
⁴SEBS is a polystyrene-poly(ethylene-butene)-polystyrene block copolymer as supplied by Kraton Polymers as Kraton G 1651.

Processing conditions. All examples were prepared by melt mixing using a 30 millimeter Werner and Pfleider twin screw extruder operating at a screw speed of 350 rotations per minute, with a feed rate of 22.7 kilograms per hour and a maximum temperature of 290° C. The processing conditions and additional information on the disposition of the barrels and the temperature zones for the extruder are given in Table 2.

TABLE 2

| | | | | | | | | | | | | |
|---|---|---|---|---|---|---|---|---|---|---|---|---|
| Temp Profile: | Barrel | 1 | 2 | 3 | 4 | 5 | 6 | 7 | 8 | 9 | 10 | Die |
| | Temp ° C. | 260 | 280 | 280 | 290 | 290 | 290 | 290 | 290 | 290 | 290 | 290 |
| RPM: 350 | | | | | | | | | | | | |
| Rate: 22.7 Kg/hr | | | | | | | | | | | | |

### Comparative Example 1

Components 1-10 were added at the feed throat of a 30 millimeter Werner and Pfleider twin screw extruder and melt mixed according to the conditions described in Table 2. The resulting thermoplastic composition was extruded and cut into pellets of approximately ¼″ in length, and formed into bars by injection molding the pellets, and tested for Notched Izod impact strength.

### Comparative Example 2

Components 1-9 were added at the feed throat of a 30 millimeter Werner and Pfleider twin screw extruder. Component 10 (talc masterbatch) was added to a downstream feedport of the extruder and the whole was melt mixed according to the conditions described in Table 2. The resulting thermoplastic composition was extruded and cut into pellets of approximately ¼″ in length, and formed into bars by injection molding the pellets, and tested for Notched Izod impact strength.

### Example 1

Components 1-7 were added at the feed throat of a 30 millimeter Werner and Pfleider twin screw extruder. Components 8 (polyamide), 9 (carbon black masterbatch) and 10 (talc masterbatch) were added to a downstream feedport of the extruder and the whole was melt mixed according to the conditions described in Table 2. The resulting thermoplastic composition was extruded and cut into pellets of approximately ¼″ in length, and formed into bars by injection molding the pellets, and tested for Notched Izod impact strength.

All test samples were ISO specimens and molded by Van Dorn 85T press. Melt temp: 298° C. and mold temp: 88° C. Materials were dried for 4 hrs at temperature of 230° F. before molding. Notched Izod impact strength was evaluated according to ASTM D256, at 23° C. and −30° C. The Dynatup tests were run according to ASTM D3763 using a Dynatup 8250 at 23° C. and −30° C., and the results are shown in units of Joules (J). Tensile yield strength (TYS) was measured according to ISO 527 using a MTS 5/G. Tensile elongation (TE) was measured according to ISO 527. Vicat B120 measurements were determined using ISO 306 standards. Melt volume rate was determined using the Melt Volume Rate test ISO 1133 performed at 300° C. with a load of 5 kilograms (kg). Evaluation of polyphenylene ether particle size was performed by extracting polyphenylene ether using toluene from the cross-section of an injection molded Izod bar. PPE particle size, as defined by the resulting void, was measured using software (Clemex Vision) by counting and calculating the cavities of PPE/PA compositions in the SEM images (each at 2kX magnification for comparative purposes) in FIGS. 1-3.

Table 3 summarizes physical and flow properties of a 19% talc filled PPE/PA composition prepared using different feedings according to Comparative Examples 1 and 2, and Example 1, using the components and proportions of Table 1. The values for Vicat B120 measurements are in ° C. The values for Izod (notched and unnotched) testing are in kilojoules per square meter. Dynatup values are in Joules. Tensile yield strength (TYS) is in megapascals. Tensile elongation (TE) is in percent. Melt volume rate is in cubic centimeters per 10 minutes.

TABLE 3

| | | Izod - | Izod - | Izod - | | | | | |
|---|---|---|---|---|---|---|---|---|---|
| | Vicat, | unnotched, | notched, | notched, | Dynatup | Dynatup @ | | | MVR @ |
| | B120 | 23° C. | 23° C. | −30° C. | @ 23° C. | −30° C. | TYS | TE | 280° C./5 kg |
| Comp. | 199 | 41 | 2.1 | 2.1 | 2.0 | 1.8 | 58 | 4 | 17.2 |
| Example 1 | | | | | | | | | |
| Comp. | 198 | 56 | 3.8 | 3.5 | 4.5 | 3.3 | 58 | 7 | 16.3 |
| Example 2 | | | | | | | | | |
| Example 1 | 204 | 66 | 5.0 | 4.6 | 12.6 | 6.1 | 61 | 10 | 12.4 |

The physical properties of Example 1 exhibit an improvement over the physical properties of Comparative Examples 1 and 2 in almost all categories. Increases in the notched Izod tests at both 23 and −30° C. for Example 1 over both Comparison Examples 1 and 2 demonstrate a surprising increase in tensile strength of the composition using an extruder where the polyamide, carbon black masterbatch, and talc masterbatch are added downstream of the poly(arylene ether).

Table 4 summarizes the maximum poly(arylene ether) particle sizes of the above described 19% talc filled PPE/PA composition made by different feedings according to Comparative Examples 1 and 2, and Example 1. Likewise, Table 5 summarizes the maximum cross sectional areas for the above described compositions formed in Comparative Example 2 and Example 1. In both sets of data from Tables 4 and 5, a significant reduction in particle size is seen in Example 1 over the Comparative Examples 1 and 2 by each morphological measure.

TABLE 4

| | PPE Particle Size (μm) |
|---|---|
| | Max |
| Comp. Example 1 | 12.0 |
| Comp. Example 2 | 3.4 |
| Example 1 | 2.1 |

TABLE 5

| | PPE Particle Area (μm²) |
|---|---|
| | Max |
| Comp. Example 1 | —* |
| Comp. Example 2 | 9.1 |
| Example 1 | 3.5 |

*Due to the high irregularity in shape and the large variation in size of the PPE particles in Comparative Example 1, maximum cross sectional area was not quantified for this sample.

Turning now to the figures, FIG. 1 shows a scanning-electron micrograph (SEM) image at 2 kX magnification of a dispersed poly(arylene ether) phase in a first comparative example prepared by feeding all components only into the feedthroat of an extruder. The voids left after extraction of the polyphenylene ether in this instance (where “A” in FIG. 1 shows an example of a void) are irregular in shape and represent the maximum particle size of the PPE dispersed phase of 12 micrometers, as seen in the data from Table 4. Maximum cross sectional area was not obtainable for this comparative example (see * above).

FIG. 2 shows a scanning-electron micrograph (SEM) image at 2 kX magnification of the dispersed poly(arylene ether) phase in Comparative Example 2, prepared by feeding all components except talc masterbatch into the feedthroat of extruder, and feeding the talc masterbatch into a downstream feedport. The maximum poly(arylene ether) particle size measured from the voids resulting from extraction of the poly(arylene ether) for this comparative example (where “B” in FIG. 2 shows an example of a void) is 3.4 micrometers (elm) as seen in the data from Table 4, and the maximum cross-sectional area is 9.1 square micrometers (μm²), as seen in the data from Table 5. Particle size at least is substantially reduced by comparison with FIG. 1, and the composition of Comparative Example 2 exhibits a higher 23° C. Notched Izod impact strength of 3.8 kJ/m² versus 2.1 kJ/m² as seen in Comparative Example 1 in Table 3.

FIG. 3 shows a scanning-electron micrograph (SEM) image at 2 kX magnification of the dispersed poly(phenylene ether) phase in Example 1 prepared by feeding polyamide, talc masterbatch and carbon black masterbatch into a downstream feedport of the extruder, and the remaining components into the feedthroat of extruder. The maximum particle size measured for this example is further reduced over the comparative examples at 2.1 micrometers (μm) as seen in the data from Table 4, and the maximum cross sectional area of the particles is 3.5 square micrometers (μm²), as seen in the data from Table 5. The composition of Example 1 exhibits higher 23° C. Notched Izod impact strength of 5 kJ/m² versus 2.1 kJ/m² for Comparative Example 1, as seen in the data in Table 3.

FIG. 4 represents the particle size distribution of Comparative Example 2, and FIG. 5 represents the particle size distribution of Example 1. As seen in the data, the overall distribution of poly(arylene ether) particles is broader for Comparative Example 1, with greater than 88.3% of particles having a particle size of less than 1.2 micrometers, than for Example 1, with greater than 97.6% of particles having a size less than 1.2 micrometers.

Similarly, FIG. 6 represents the particle cross-sectional area distribution of Comparative Example 2, and FIG. 7 represents the particle cross-sectional area distribution of Example 1. As seen in the data, for example, the overall distribution of poly(arylene ether) particle cross-sectional areas is broader for Comparative Example 1, with greater than 92.2% of particles having a particle cross-sectional area of less than 1.5 μm², than for Example 1, with greater than 99.1% of particles having a cross-sectional area less than 1.5 μm².

While the invention has been described with reference to various embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

All cited patents are incorporated by reference herein.

1. A composition comprising
a compatibilized blend of a poly(arylene ether) and a polyamide;
carbon black; and
a mineral filler;
wherein the poly(arylene ether) is dispersed as particles in a polyamide matrix and greater than or equal to 95% of the poly(arylene ether) particles have a cross sectional area less than or equal to 2.5 square micrometers.

2. The composition of claim 1 wherein greater than or equal to 95% of the particles have a cross sectional area less than or equal to 2.0 square micrometers.

3. The composition of claim 2 wherein greater than or equal to 95% of the particles have a cross sectional area less than or equal to 1.5 square micrometers.

4. The composition of claim 1 wherein the composition further comprises an impact modifier.

5. The composition of claim 1 where the amount of carbon black is 0.001 to 5 wt % of the composition.

6. The composition of claim 1 where the mineral filler comprises talc.

7. A composition comprising
a compatibilized blend of a poly(arylene ether) and a polyamide;
carbon black; and
a mineral filler;
wherein the poly(arylene ether) is dispersed as particles in a polyamide matrix and the particles have a maximum particle size of less than or equal to 3.2 micrometers.

8. The composition of claim 7 wherein the maximum particle size is less than or equal to 3.0 micrometers.

9. The composition of claim 8 wherein the maximum particle size is less than or equal to 2.8 micrometers.

10. The composition of claim 7 wherein the composition further comprises an impact modifier.

11. The composition of claim 7 where the amount of carbon black is 0.001 to 5 wt % of the composition.

12. The composition of claim 1 where the mineral filler is talc.

13. A composition comprising
a compatibilized blend of a poly(arylene ether) and a polyamide;
carbon black; and
a mineral filler;
wherein the poly(arylene ether) is dispersed as particles in a polyamide matrix and greater than or equal to 95% of the poly(arylene ether) particles have a cross sectional area less than or equal to 2.5 square micrometers, and the particles have a maximum particle size of less than or equal to 3.2 micrometers.

14. The composition of claim 13 wherein the composition further comprises an impact modifier.

15. The composition of claim 13 where the amount of carbon black is 0.001 to 5 wt % of the composition.

16. The composition of claim 13 where the mineral filler comprises talc.

17. The composition of claim 13 wherein greater than or equal to 95% of the poly(arylene ether) particles have a cross sectional area less than or equal to 2.0 square micrometers, and the particles have a maximum particle size of less than or equal to 3.0 micrometers.

18. A method of making a thermoplastic composition comprising:
adding a compatibilized poly(arylene ether) to a feedthroat of an extruder;
adding a polyamide downstream of the feedthroat;
adding a first masterbatch comprising a polyamide and a carbon black downstream of the feedthroat; and
adding a second masterbatch comprising a polyamide and a mineral filler downstream of the feedthroat.

19. The method of claim 18 where the thermoplastic composition comprises particles of a poly(arylene ether), and greater than or equal to 95% of the poly(arylene ether) particles have a cross sectional area less than or equal to 2.5 square micrometers, and the particles have a maximum particle size of less than or equal to 3.2 micrometers.

20. A method of making a thermoplastic composition comprising:
adding a mixture comprising a poly(arylene ether), a compatibilizer, and an impact modifier to a feedthroat of an extruder;
adding a first masterbatch comprising a polyamide and carbon black to the extruder downstream of the feedthroat; and
adding a second masterbatch comprising a polyamide and talc to the extruder downstream of the feedthroat.
wherein thermoplastic composition comprises particles of a poly(arylene ether), and greater than or equal to 95% of the poly(arylene ether) particles have a cross sectional area less than or equal to 2.0 square micrometers, and the particles have a maximum particle size of less than or equal to 3.0 micrometers.
